(19) United States
(12) Patent Application Publication
(10) Pub. No.: US 2010/0035746 A1
(43) Pub. Date: Feb. 11, 2010

(54) Methods for Making Carbide-Metal Nanocomposite Powders

(75) Inventors: Hong Yong Sohn, Salt Lake City, UT (US); Zhigang Zak Fang, Salt Lake City, UT (US); Taegong Ryu, Salt Lake City, UT (US); Gilsoo Han, Salt Lake City, UT (US)

Correspondence Address: THORPE NORTH & WESTERN, LLP., P.O. Box 1219, SANDY, UT, 84091-1219, US

(73) Assignee: University of Utah Research Foundation, Salt Lake City, UT (US)

(21) Appl. No.: 12/306,226

(22) PCT Filed: Jun. 20, 2007
(86) PCT No.: PCT/US07/14498

§ 371 Date: Oct. 14, 2009

Related U.S. Application Data
(60) Provisional application No. 60/815,315, filed on Jun. 20, 2006.

(51) Int. Cl. C04B 35/56

(52) U.S. Cl. 501/91; 501/87; 501/93; 501/88

(57) ABSTRACT

This chemical vapor synthesis process was designed so that a metal carbide precursor and a secondary metal precursor are separately or together fed into each evaporator in a reactor by specially designed precursor feeders, either simultaneously or sequentially. The reduction and carburization of the vaporized precursors by gaseous mixtures produces carbide-metal nanocomposite powders. The product can be a very uniform mixture of the constituent powders or a uniform agglomerate, which is important to ensure a high quality of bulk cemented metal carbide product after consolidation and sintering. These nanocomposite powders can be readily characterized using XRD, carbon analyzer and TEM.

### RELATED APPLICATIONS

This application claims the benefit of U.S. Provisional Application Ser. No. 60/815,315, filed on Jun. 20, 2006, which is incorporated herein by reference.

### GOVERNMENT INTEREST

The Government of the United States of America may have certain rights to this invention pursuant to Department of Energy Cooperative Agreement No. DE-FC36-04GO14041.

### FIELD OF THE INVENTION

This invention relates to the field of nanocomposite powders prepared by chemical vapor synthesis processes. Accordingly, the present invention involves the fields of chemistry and materials science.

### BACKGROUND OF THE INVENTION

Nanostructured tungsten carbide-cobalt (WC-Co) was among the first group of materials that demonstrated the potential of nanostructured materials. Cemented tungsten carbide is indispensable in many industrial fields with its outstanding properties of high hardness and good wear resistance. Such nanopowders are applied to tools in the metalworking, drilling, and mining industries under severe conditions of high pressure, high temperature, and corrosive environment, However, tungsten carbide's performance has been limited by brittleness and relatively low toughness compared to metal alloys. As such, cobalt can be added as a ductile metal matrix to improve the fracture toughness, which is a function of microstructural variables including metal content, grain sizes, and contiguity of tungsten carbide grains. Because the ductile metal reduces hardness, in the case of WC-Co composites, the cobalt content is typically limited to the range of 3-16% by weight for most commercial applications. The particle size of tungsten carbide also plays an important role in improving the mechanical properties of WC-Co cermets, such as hardness, compressive strength, and transverse rupture strength.

The current common commercial practice for producing WC-Co, starting from tungsten-containing ore such as Wolframite and Scheelite, involves complex multi-step chemical and thermal processes to produce tungsten carbide powder from the minerals. Major steps are as follows:
Ore (Wolframite or Scheelite)→APT (Ammonium paratungstate)→→Tungsten Oxide WO₃→W metal powder→Tungsten carbide WC.

The process from ore to APT involves acid digestion and extraction. Equally complex processes are needed for making cobalt metal powder. In addition, the constituent metals are expensive to produce in pure form and the processes for tungsten production are energy-intensive.

Nanosized powders of metal carbides have been produced by various methods such as the thermo-chemical spray drying process, mechanical alloying (MA), and chemical vapor condensation (CVC). During the spray drying process used to produce nanostructured WC-Co powder, APT and cobalt nitrate precursor are spray dried first. The spray dried granules are reduced and carburized in a fluidized bed in a single run cycle. This forms, from an aqueous solution, ammonium salts containing tungsten and cobalt at the desired ratio, which require numerous aqueous process steps of purification and crystallization. It can also be difficult to maintain control of process conditions associated with conventional processes. Furthermore, production of fine powders from these aqueous processes requires spray drying, which is highly energy-intensive, and also generates large amounts of waste liquids. It would be advantageous if carbide nanocomposite powders could be produced directly in a powder form using less energy and fewer chemical steps.

### SUMMARY

The present invention is directed to improving the desired properties of nanostructured powders by using a chemical vapor synthesis process. One aspect of the invention is directed to a method of making a carbide-metal nanocomposite powder. A metal carbide precursor can be introduced into a reactor at a temperature sufficient to vaporize the metal carbide precursor in the presence of a carburizing agent to form a nanosize metal carbide powder. A secondary metal precursor can also be separately introduced into the reactor at a temperature sufficient to vaporize the secondary metal precursor in the presence of a reducing agent and the nanosize metal carbide to form a reduced metal.

### BRIEF DESCRIPTIONS OF THE DRAWINGS

FIG. 1 shows X-ray diffraction (XRD) patterns of the product obtained from (a) WCl₆ with a feeding rate of 0.04 g/min and (b) CoCl₂ with a feeding rate of 0.04 g/min under the following conditions: reaction temperature of 1400° C., total flow rate of 1100 ml/min, CH₄ feeding rate of 100 ml/min, and H₂ feeding rate of 500 ml/min in accordance with one aspect of the present invention.

FIG. 2 shows X-ray diffraction patterns of the product from (a) mixture feeding (molar ratio of WCl₆ to CoCl₂: 1.1, and feeding rate of mixture: 0.053 g/min), and (b) modified arrangement (feeding rate of WCl₆: 0.06 g/min, and feeding rate of CoCl₂: 0.02 g/min) under the following conditions: reaction temperature of 1400° C., CH₄ feeding rate of 100 ml/min, H₂ feeding rate of 0 ml/min, and total flow rate of 600 ml/min in accordance with one aspect of the present invention.

FIG. 3 shows X-ray diffraction patterns of the product obtained at various C/W weight ratios (a) [C/W]=23.5, (b) [C/W]=5.8, (c) [C/W]=2.3 under the following conditions: reaction temperature of 1400° C., total flow rate of 1100 ml/min, WCl₆ feeding rate of 0.06 g/min, and CoCl₂ feeding rate of 0.02 g/min in accordance with another aspect of the present invention.

FIG. 4 shows effect of reaction temperature on the weight ratio of W₂C/WC under the following conditions: total flow rate of 1100 ml/min, CH₄ feeding rate of 10 ml/min, H₂ feeding rate of 0 ml/min, WCl₆ feeding rate of 0.06 g/min, and CoCl₂ feeding rate of 0.02 g/min in accordance with one aspect of the present invention.

FIG. 5 shows X-ray diffraction patterns of the product obtained at various H₂/CH₄ molar ratios (a) [H₂/CH₄]=0, (b) [H₂/CH₄]=1, and (c) [H₂/CH₄]=5 under the following conditions: total flow rate of 1100 ml/min, CH₄ feeding rate of 10 ml/min, H₂ feeding rate of (a) 0 ml/min, (b) 10 ml/min, (c) 50 ml/min, WCl₆ feeding rate of 0.06 g/min, and CoCl₂ feeding rate of 0.02 gamin in accordance with still another aspect of the present invention.

FIG. 6 shows X-ray diffraction patterns of the product obtained from (a) 11 KW, (b) 15 KW, and (c) 19 KW under the following conditions: plasma Ar flow rate of 56 L/min (at 25° C. and 0.85 atm), feeding rate of WCl₆ of 3.5 g/min, feeding rate of CH₄ of 1.5 L/min, and flow rate of Ar to carry WCl₆ of 1 L/min in accordance with yet another aspect of the present invention.

FIG. 7 shows X-ray diffraction patterns of the product obtained by H₂ addition into the plasma flame (a) only Ar, (b) Ar-2.2% H₂, and (c) Ar-6.9% H₂ under the following conditions: feeding rate of WCl₆ of 3.5 g/min, plasma Ar flow rate of 29 L/min (at 25° C. and 0.85 atm), flow rate of Ar to carry WCl₆ of 1 L/min in accordance with another aspect of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “an additive” includes one or more of such additives, reference to “a filter” includes reference to one or more of such filters, and reference to “introducing” includes reference to one or more of such steps.

As used herein, “nanocomposite” refers to a material having at least one dimension in the nanometer range. Nanocomposite materials can be micron sized while including nanosized compositional regions, e.g. a micron size agglomerate of nanosized materials. As a general matter, nanocomposites can have a smallest physical dimension of less than one micron, although in some aspects the dimensions can be less than about 100 nm.

As used herein, “elemental metal precursor” refers to a precursor material which when reacted, e.g. reduced, forms an elemental metal as opposed to a metal compound or alloy, e.g. metal carbide.

As used herein, “metal” refers to any element, alloy or compound which includes a metal or semi-metal.

As used herein, “vaporizing” refers to a process of forming vapor of a material, i.e. as opposed to a solid or liquid.

As used herein, the term “substantially” or “substantial” refers to the complete or nearly complete extent or degree of an action, characteristic, property, state, structure, item, or result. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of action, characteristic, property, state, structure, item, or result. For example, a composition that is “substantially free of” particles would either completely lack particles, or so nearly completely lack particles that the relevant effect would be the same as if it completely lacked particles. In other words, a composition that is “substantially free of” an ingredient or element may still contain such an item as long as there is no measurable difference on the effect of interest.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 micron to about 5 microns” should be interpreted to include not only the explicitly recited values of about 1 micron to about 5 microns, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described. As an example, the term “about” also includes “exactly” consistent with the above guidance and without unduly limiting equivalents which would otherwise be available. Further, all volumetric flow rates of gases reported in this application are at 25° C. and 0.85 atm unless otherwise noted.

### Embodiments of the Invention

Refractory carbide powders are used in the metalworking, drilling, and mining industries because such powders have desirable characteristics including high hardness and good wear resistance. As such, these materials are excellent candidates for use in severe conditions, including high pressure, high temperature, and corrosive environments. The present invention provides methods of making carbide-metal nanocomposite powders. Specifically, the method includes a chemical vapor synthesis process. The present process has an advantage in producing nanostructured powders having high composition uniformity, high purity, and often having grain sizes of less than 30 nm. The chemical vapor synthesis process can be carried out by the reduction and carburization of a vaporized reactant precursor by the addition of gaseous carburization sources such as a hydrocarbon.

One aspect of the invention is directed to a method of making a carbide-metal nanocomposite powder by introducing a metal carbide precursor into a reactor at a temperature sufficient to vaporize the metal carbide precursor in the presence of a carburizing agent to form a nanosize metal carbide. The metal carbide in the composite powder can comprise or consist essentially of, without limitation, the carbides of W, Mo, Ta, Nb, Zr, Hf, Cr, V, Ti, Si and combinations thereof. To apply the present invention to these carbides, precursors can be introduced in a manner similar to the precursors illustrated for tungsten carbide.

A secondary metal precursor can also be introduced into the reactor at a temperature sufficient to vaporize the secondary metal precursor in the presence of a reducing agent and the nanosize metal carbide to form a reduced metal. The metal carbide precursor and the secondary metal precursor can be introduced into the reactor sequentially as described in more detail below, or simultaneously. Regardless of when the precursors are added, the precursors can be added separately in some embodiments. Alternatively, the precursors can be added together and simultaneously. The precursor materials can typically be introduced as vapors or powders or as slurries or solutions mixed with a liquid including but not limited to hydrocarbons, alcohols or aqueous solutions, while the reducing agents and carburizing agents can be introduced as gases. In one specific aspect of the present invention, the precursors can be introduced as powders.

Another aspect of the present invention includes the step of introducing an additive to the reactor. There are many types of additives that can be used with the present invention. One type of additive includes a secondary metal carbide precursor. Non-limiting types of secondary metal carbides include chlorides of titanium, tantalum, vanadium, chromium, molybdenum, niobium, chromium, molybdenum, silicon, zirconium, hafnium, and combinations thereof. Generally, these secondary metal carbide precursors can be chosen in a manner similar to the primary metal carbide precursor. These carbides can all be produced by reaction of CH₄ (or other suitable carburizing agent) with respective chlorides or precursors of the constituent metals as described in more detail below. The exact proportion of secondary precursor to primary precursor can primarily depend on the desired product. Typically, these secondary metal carbide precursors can be introduced separately from the primary metal carbide precursors.

Another type of additive includes a grain growth inhibitor. Non-limiting examples of suitable growth inhibitors include the carbides of V, Ta and Cr, and alloys or composites thereof. Grain growth inhibitors can generally comprise from about 0.5 to about 10 mole % with respect to the associated carbide. Further, if an alloy or an intermetallic compound is desired within the metal matrix, additional metal chlorides can be added to produce such a matrix material simultaneously with the metal carbide and/or reduced metal. For example, both a cobalt precursor and a chromium precursor can be introduced. Other combinations of precursors can be selected based on the desired composition of the final nanocomposite powder.

The present invention includes using a carburizing agent and a reducing agent. Non-limiting examples of carburizing agents include or consist essentially of methane, ethane, propane, higher hydrocarbons such as heptane, benzene, or any other volatile hydrocarbon which can act as a carburizing agent, and combinations thereof. For example, carbon monoxide can be used as a carburizing agent. In one aspect, methane can be the carburizing agent. Compounds that provide control of the amount of carbon reacted and are stable up to a high temperature can be carburizing agents as well. Non-limiting examples of reducing agents include hydrogen, carbon monoxide, methane, reformed natural gas, magnesium vapor, and combinations thereof. In one embodiment, the carburizing agent and the reducing agent can be the same. In another embodiment, the carburizing agent and the reducing agent can be different. The amount of carburizing and reducing agent can vary, although approximate stoichiometric ratios with the respective precursors with a slight excess of carburizing and reducing agent can be used. A slight (e.g. 10-20%) excess can help to ensure complete reaction while minimizing unreacted carburizing and reducing agent in the product.

One aspect of the invention includes using a metal carbide precursor that is a metal halide and/or using a secondary metal precursor that is a metal halide. Non-limiting examples of halides that can be used with the present invention include fluoride, chloride, bromide, iodide, and combinations thereof. One specific aspect of the invention includes using chloride as the halide. In one aspect, the metal carbide precursor can be a carbonyl. Other metal carbide precursors can include compounds that have relatively low evaporating temperatures as well as being easily reduced by hydrogen. As such, metal carbide precursors that can be used with the present invention include, without limitation, tungsten hexachloride (WCl₆), tungsten hexafluoride (WF₆), tungsten hexacarbonyl (W(CO)₆), ammonium paratungstate [H)[H₂W₁₂O₄₂].4H₂O], other volatile or soluble tungsten compounds (e.g. ammonium metatungstate, etc.), and combinations thereof. Carbides of other metals, e.g. Ti, V, W, Mo, Ta, Nb, Zr, Hf, Cr, and Si, can be produced by using volatile or soluble compounds of these metals such as, without limitation, titanium bromides, titanium chlorides, vanadium chlorides in the same manner as those of tungsten. These same principles can be applied to both refractory and non-refractory metal carbides.

One specific aspect of the present invention includes using WCl₆ as the refractory metal carbide precursor. In one very specific embodiment of the present invention, the secondary metal precursor can be added into the reactor after the WCl₆ forms the nanosize refractory metal carbide. For example, the secondary metal precursor can be a cobalt containing precursor, such that a uniform mixture of nanosized WC and Co is produced. The metal carbide precursor materials can generally be provided in a powder form. Generally, the precursor powders can have an average size from about 10 μm to about 500 μm. In one aspect, the size can be from about 50 μm to about 100 μm, although other sizes can be formed in accordance with the present invention.

The present invention includes introducing a secondary metal precursor. In one aspect the secondary metal precursor can be a second metal carbide precursor. Alternatively, the secondary metal precursor can be an elemental metal precursor or a combination of metal precursors which do not form metal carbides. The secondary metal precursor can be chosen based on its ability to avoid formation of carbides and capacity to be reduced to the desired metal during reaction. This can be a function of the thermodynamics involved, the composition of the reducing agent, metal carbide precursor, and the like. Further, suitable precursors can be chosen to yield a reduced metal without being carburized during powder synthesis as well as any subsequent sintering processing. Thus, any metal that will carburize during the sintering step, even if it is reduced to metal during powder formation, may not be suitable for some applications. Non-limiting examples of metals that can be included in secondary metal precursors for use with the present invention include cobalt, nickel, iron, manganese, aluminum, and combinations thereof. The secondary precursor can be in the form of a corresponding metal halide or carbonyl. Other secondary metal precursors can include compounds that have relatively low evaporating temperatures as well as being easily reduced by hydrogen. One very specific aspect of the present invention includes using cobalt chloride (CoCl₂) as the secondary metal precursor.

The present invention uses a secondary metal precursor to form a reduced metal. One specific aspect of the present invention includes a method of making the nanocomposite powder that contains from about 1 wt % to about 30 wt % of the reduced metal. The secondary metal precursor can be chosen based on the desired final product characteristics. For example, a composite WC-Co powder can benefit from the ductility of Co in order to improve the fracture toughness of the composite. The nanocomposite powders produced by the methods of the present invention can have reduced excess carbon content. When the composite powders produced by the process described in this invention are compacted into a bulk shape for processing in a subsequent sintering step, up to about 5% excess carbon over the amount to carburize the tungsten content can be tolerated. However, any excess carbon beyond this level generally requires an additional removal step before sintering. Therefore, it can be advantageous to directly produce composite powders that contain excess carbon of less than 5%, and in some cases less than about 3%. The methods of the present invention allow for a convenient and effective approach to achieve such high quality starting materials for subsequent sintering processing.

The present invention can also include the step of collecting the nanosize metal carbide and the reduced metal as a nanocomposite powder. The nanocomposite powder can typically be collected using a filter such as Teflon-coated polyester, however other powder collection techniques can also be suitable such as settling vessels, liquid contactors, or the like.

The respective powder flow rates of metal carbide precursor and secondary metal precursor can depend on the desired final product and is not particularly limited. In one aspect, the mass ratio of precursor to secondary metal precursor can be from about 1 to about 50. In another aspect, the nanocomposite powder can contain from about 1 wt % to about 30 wt % of the reduced metal. In yet another aspect, the nanocomposite powder can contain from about 5 wt % to about 20 wt % of the reduced metal. Further, the amount of carburizing agent per metal carbide precursor can vary depending on the specific materials chosen; however, from about 1 to 10 times the stoichiometric amount of carburizing agent per mole of corresponding precursor can be used. Similarly, the amount of reducing agent per secondary metal precursor can vary depending on the specific materials chosen; however, from 1 to 10 times the stoichiometric amount of reducing agent per mole of precursor, taking into consideration the reducing agent generated from the carburizing agent, can be used. Ranges outside these, greater or substoichiometric amounts, can also be used depending on the particular apparatus, process conditions, and desired product.

The temperature of the reaction is one factor that influences the products of the present invention. One aspect of the present invention includes a method of making a carbide nanocomposite powder wherein the temperature of the reaction can be from about 500° C. to about 10,000° C. Another more specific aspect of the present invention includes practicing the invention wherein the temperature of the reaction can be about 1300° C. to about 1450° C. One very specific aspect of the invention includes practicing the invention wherein the temperature of the reaction can be about 1400° C. In another aspect, the precursors, reducing agents, and carburizing agent can be directly injected into the plasma core and/or high temperature areas of a plasma reactor with temperatures above about 7,000° C. and in some cases about 10,000° C. or even greater. As such, the reactants can be very rapidly volatilized and can then react more rapidly.

Generally, the methods of the present invention are performed at about atmospheric pressure. However, minor pressure fluctuation may be present with the change of temperature during the reaction. Additionally, the precursors described herein generally can be vaporized from a solid or liquid. In one aspect, the precursors can be vaporized from a solid state. Further, the methods of the present invention typically produce the final nanopowders based on a single stage (dual input) reactor without further processing needed. Although additional processing can be useful in some scenarios, the nanopowders of the present invention are highly uniformly mixed powders. Additional processing may include, but is not limited to, cleaning, packaging, and the like.

Without being bound to any particular theory, it is thought that under sequential introduction of metal carbide and secondary metal precursors, a majority of the metal carbide nanosized particles form and become embedded in agglomerates of the secondary metal. However, there can also be significant portions of free metal carbide and metal powders, which are intimately mixed. One specific aspect of the invention includes making a carbide-metal nanocomposite powder wherein the nanosize metal carbide is embedded with the reduced metal in nanosized powder particles. The metal carbides and metals produced herein may be in the form of agglomerates that contain individual nanosized particles of metal carbides and metals, e.g. cemented by carbon. Alternatively, in yet another embodiment, the carbide-metal nanocomposite powders can include metal carbides at least partially coated by the reduced metal. Regardless of the particular product, the composition can substantially avoid formation of subcarbides or other mixed compounds, e.g. tertiary compounds.

Another aspect of the present invention includes making a carbide-metal nanocomposite powder, wherein the nanosize metal carbide and the reduced metal form a substantially homogenous mixture. The uniformity of the powder mixture decreases the contact between nanosize metal carbide particles that can lead to grain growth, and increases the nanosize metal carbide-reduced metal contact. Therefore, in one aspect, a method of controlling grain size of a nanosized carbide metal includes forming nanosized carbide metals uniformly mixed in a nanosized metal particle matrix. The particular product produced from the above alternatives can be a function of reaction conditions, e.g. time, temperature, etc., as well as precursor and reducing agent compositions which can be readily adjusted by those skilled in the art based on the description provided herein. As a general rule, any suitable pressure can be used, e.g. 0 to about 10 atm, although about 1 atm can be useful to avoid complex vacuum or high pressure equipment.

One specific aspect of the present invention includes making a carbide-metal nanocomposite powder, wherein the nanosize metal carbide and/or the reduced metal formed has a spheroidal shape. Another specific aspect of the present invention includes making a carbide-metal nanocomposite powder, wherein the nanosize metal carbide and/or the reduced metal formed has a grain size of less than 50 nm and in some cases less than 30 nm. Typically, the nanocomposite powder has a powder size from about 5 nm to about 100 nm. In one aspect, the nanocomposite powder can be from about 15 nm to about 30 nm. Although results and conditions can vary, often larger particles can be produced by extending reaction times, e.g. by providing an extended length of reactor volume. Alternatively, a seed powder having the same composition as the desired carbide can be injected along with the precursor(s) and reducing agent. Such an approach can produce particles several hundred nanometers in size. Thus, in some embodiments of the present invention, the nanocomposite powder can range from about 2 nm to about 1 micron, and in some cases from about 100 nm to about 800 nm.

The size and morphology can be observed by x-ray diffraction, transmission electron microscopy, scanning electron microscopy, and other methods known to those of skill in the art. The size of the particles can be calculated based on x-ray diffraction results using the Scherrer equation.

Crystallite Size=(Kλ)/(FW Cos θ) Scherrer Equation
K is the shape factor of the average crystallite, and θ is the peak position.

Variables such as reaction temperature, carbon potential and reducing agent flow rate can affect the synthesis of nanosized carbide-metal composites. For example, the ratio of carburizing agent to reducing agent can affect the formation of the nanosized metal carbide. By increasing the ratio of CH₄ to H₂, an increase in the degree of carburization of WCl₆ may result. As the feeding rate of H₂ increases, the carbon potential can decrease and the degree of carburization can also decrease. Additionally, CE alone, without H₂, can be sufficient to reduce and carburize WCl₆ into WC.

Temperature can also influence the degree of carburization of the metal carbide precursor and the grain size of the nanosize metal carbide formed by practicing the present invention. Generally, increasing the reaction temperature can increase the degree of carburization.

The methods of the present invention may further include the step of rapid cooling. Fine microstructural sizes present in carbide nanocomposite powder described herein may be preserved by rapid cooling.

### EXAMPLES

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The examples listed in Table 1 (covering Examples 1 through 11) each require similar parameters. The apparatus used to perform the experiments includes powder feeders, a vertical reactor, powder collectors, an off gas scrubber, and a Bunsen burner. Each powder feeder comprises a syringe pump, a vibrator, a carrier gas line, a sample container, and a sample delivery line. The reactor includes an alumina tube with 6 cm inner diameter and 1.50 m length placed in a vertical furnace with silicon carbide heating elements. The reactor was purged with Argon gas for 20 minutes before and after each experiment. A mixture of CH₄ and argon and optionally H₂ was fed into the reactor. An evaporator, in which reactant precursors are vaporized, was placed at a position inside the reactor.

TABLE 1

| | | | | | | Total |
|---|---|---|---|---|---|---|
| | | | | | | flow |
| | WCl₆ | CoCl₂ | | H₂ rate | Reaction | rate |
| | rate | rate | CH₄ rate | (ml/ | Temperature | (ml/ |
| | (g/min) | (g/min) | (ml/min) | min) | (° C.) | min) |
| Example 1 | 0.03 | N/A | 100 | 500 | 1400 | 1100 |
| Example 2 | N/A | 0.4 | 100 | 500 | 1400 | 1100 |
| Example 3 | 0.053 | 0.053 | 100 | 0 | 1400 | 600 |
| Example 4 | 0.06 | 0.02 | 100 | 0 | 1400 | 600 |
| Example 5 | 0.06 | 0.02 | 100 | 0 | 1400 | 1100 |
| Example 6 | 0.06 | 0.02 | 25 | 0 | 1400 | 1100 |
| Example 7 | 0.06 | 0.02 | 10 | 0 | 1400 | 1100 |
| Example 8 | 0.06 | 0.02 | 10 | 0 | 1200 | 1100 |
| Example 9 | 0.06 | 0.02 | 10 | 0 | 1300 | 1100 |
| Example | 0.06 | 0.02 | 10 | 10 | 1400 | 1100 |
| 10 | | | | | | |
| Example | 0.06 | 0.02 | 10 | 50 | 1400 | 1100 |
| 11 | | | | | | |

### Example 1

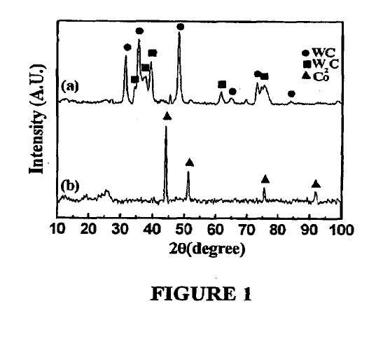

A mixture of CH₄ (99.9%), H₂ (99.9%) and argon was fed into the reactor with a CH₄ feeding rate of 100 ml/min and an H₂ feeding rate of 500 ml/min. The total flow rate was 1100 ml/min. WCl₆ (99.9%) was placed into a glass cylinder and fed into the evaporator in the reactor through a stainless steel delivery line at a rate of 0.03 g/min. The overall reaction temperature was 1400° C. The powders produced were collected using a Teflon-coated polyester filter with a pore size of 0.4 μm-1 μm in a flask. As shown in FIG. 1(a), the powder produced by these conditions contains a mixture of W₂C and WC, rather than pure WC.

### Example 2

A mixture of CH₄ (99.9%), H₂ (99.9%) and argon was fed into the reactor with a CH₄ feeding rate of 100 ml/min and an H₂ feeding rate of 500 ml/min. The total flow rate was 1100 ml/min. CoCl₂ (99.7%) was placed into a glass cylinder and fed into the evaporator in the reactor at a rate of 0.04 g/min. The overall reaction temperature was 1400° C. The powders produced were collected using a Teflon-coated polyester filter with a pore size of 0.4 μm-1 μm in a flask. As shown in FIG. 1(b), pure Co powder was produced under these conditions.

### Example 3

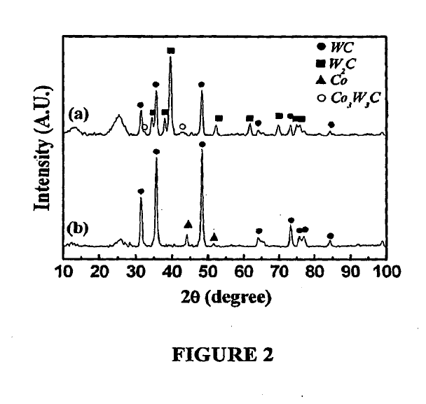

A mixture of CH₄ (99.9%) and argon was fed into the reactor with a CH₄ feeding rate of 100 ml/min. The total flow rate was 600 ml/min. WCl₆ (99.9%) was placed into a glass cylinder and fed into an evaporator in the reactor through a stainless steel delivery line at a rate of 0.053 g/min. CoCl₂ (99.7%) was placed into a glass cylinder and fed into an evaporator in the reactor at a rate of 0.053 g/min. The overall reaction temperature was 1400° C. The powders produced were collected using a Teflon-coated polyester filter with a pore size of 0.4 μm-1 μm in a flask. As shown in FIG. 2(a), the main product under this condition was W₂C, and Co₂W₃C was produced in addition to WC.

### Example 4

A mixture of CH₄ (99.9%) and argon was fed into the reactor with a CH₄ feeding rate of 100 ml/min. The total flow rate was 600 mL/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1400° C. The powders produced were collected using a Teflon-coated polyester filter with a pore size of 0.4 μm-1 μm in a flask. As shown in FIG. 2(b), the main product under these conditions was WC and Co.

### Example 5

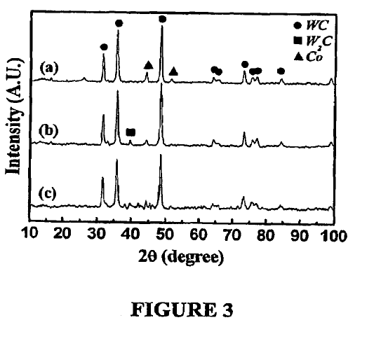

A mixture of CH₄ (99.9%) and argon was fed into the reactor with a CH₄ feeding rate of 100 ml/min. The total flow rate was 1100 ml/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1400° C. The powders produced were collected using a Teflon-coated polyester filter with a pore size of 0.4 μm-1 μm in a flask. As shown in FIG. 3(a), the main products under these conditions were WC and Co. It also appears that the higher carbon potential of these conditions increased the degree of carburization.

### Example 6

A mixture of CH₄ (99.9%) and argon was fed into the reactor with a CH₄ feeding rate of 25 ml/min. The total flow rate was 1100 ml/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1400° C. The powders produced were collected using a Teflon-coated polyester filter with a pore size of 0.4 μm-1 μm in a flask. The main products under these conditions were WC and Co, as shown in FIG. 3(b). The degree of carburization was slightly decreased compared to FIG. 3(a).

### Example 7

A mixture of CH₄ (99.9%) and argon was fed into the reactor with a CH₄ feeding rate of 10 ml/min. The total flow rate was 1100 ml/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1400° C. The powders produced are collected using a Teflon-coated polyester filter with a pore size of 0.4 μm-1 μm in a flask. As shown in FIG. 3(c), the main products produced under these conditions were WC and Co. The degree of carburization was slightly decreased compared to the example shown in FIG. 3(a).

### Example 8

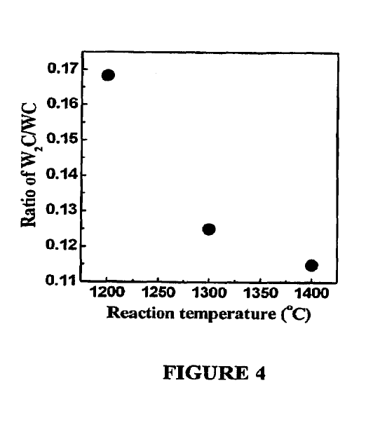

A mixture of CH₄ (99.9%) and argon was fed into the reactor with a CH₄ feeding rate of 10 ml/min. The total flow rate was 1100 ml/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1200° C. The powders produced were collected using a Teflon-coated polyester filter with a pore size of 0.4 μm-1 μm in a flask. As shown in FIG. 4, the degree of carburization with this reaction temperature was less than the degree of carburization at higher temperatures.

### Example 9

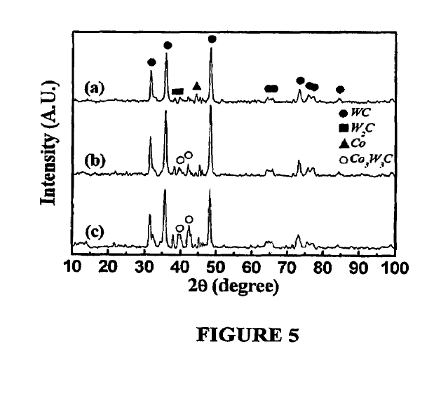

A mixture of CH₄ (99.9%) and argon was fed into the reactor with a CH₄ feeding rate of 10 ml/min. The total flow rate was 1100 ml/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1300° C. The powders produced are collected using a Teflon-coated polyester filter with a pore size of 0.4 μm-1 μm in a flask. As shown in FIG. 5(a), the main reaction product produced under these conditions was WC.

### Example 10

A mixture of CH (99.9%), H₂ (99.9%) and argon was fed into the reactor with a CH₄ feeding rate of 10 ml/min and an H₂ feeding rate of 10 ml/min. The total flow rate was 1100 ml/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1400° C. The powders produced were collected using a Teflon-coated polyester filter with a pore size of 0.4 μm-1 μm in a flask. As shown in FIG. 5(b), the main reaction product produced under these conditions was WC; however, some Co₃W₃C was also produced. This is seen by comparing FIG. 5(b) with FIG. 5(a) which is identical to FIG. 3(c) discussed in Example 7 and represents the result obtained under a similar condition except without hydrogen addition.

### Example 11

A mixture of CH₄ (99.9%), H₂ (99.9%) and argon was fed into the reactor with a CH₄ feeding rate of 10 ml/min and an H₂ feeding rate of 50 ml/min. The total flow rate was 1100 ml/min. WCl₆ (99.9%) was placed into a glass cylinder and fed into an evaporator in the reactor through a stainless steel delivery line at a rate of 0.06 g/min. CoCl₂ (99.7%) was placed into a glass cylinder and fed into an evaporator in the reactor at a rate of 0.02 g/min. The overall reaction temperature was 1400° C. The powders produced were collected using a Teflon-coated polyester filter with a pore size of 0.4 μm-1 μm in a flask. As shown in FIG. 5(c), the main reaction product produced under these conditions was WC; however, some Co₃W₃C was also produced.

Examples 12 through 17 were performed in a plasma reactor formed from a plasma torch and a graphite reactor of 7.6 cm inner diameter and 61 cm length.

### Example 12

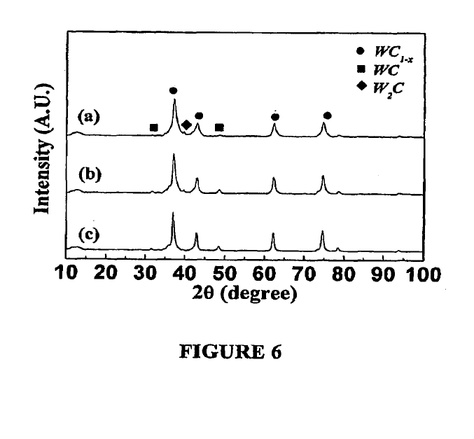

A mixture of CH₄ (99.9%) and argon was fed into a plasma flame, contained within a graphite reactor of 7.6 cm inner diameter and 61 cm length, with a CH₄ feeding rate of 1.5 L/min and an Ar feeding rate of 1 L/min. WCl₆ (99.9%) was fed into the plasma flame through a stainless steel delivery line at a rate of 3.5 g/min. The power of the plasma torch was 11 kW. The pressure of Ar to generate plasma flame was 50 psi, which resulted in a flow rate 56 L/min (at 25° C. and 0.85 atm). The powders produced were collected using a Teflon-coated polyester filter with a pore size of 0.4 μm-1 μm in a stainless steel collector. As shown in FIG. 6(a), the main product under these conditions was WC₁₋ₓ and small amounts of W₂C and WC were also present in the product.

### Example 13

A mixture of CH₄ (99.9%) and argon was fed into the plasma flame with a CH₄ feeding rate of 1.5 L/min and an Ar feeding rate of 1 L/min. WCl₆ (99.9%) was fed into the plasma flame through a stainless steel delivery line at a rate of 3.5 g/min. The power of plasma torch was 15 kW. The pressure of Ar to generate the plasma flame was 50 psi, which resulted in a flow rate 56 L/min (at 25° C. and 0.85 atm). The powders produced were collected using a Teflon-coated polyester filter with a pore size of 0.4 μm-1 μm in a stainless steel collector. As shown in FIG. 6(b), the main product under these conditions was WC₁₋ₓ and small amounts of W₂C and WC were also present in the product. The degree of carburization was slightly increased compared to FIG. 6(a).

### Example 14

A mixture of CH₄ (99.9%) and argon was fed into the plasma flame with a CH₄ feeding rate of 1.5 L/min and an Ar feeding rate of 1 L/min. WCl₆ (99.9%) was fed into the plasma flame through a stainless steel delivery line at a rate of 3.5 g/min. The power of plasma torch was 19 kW. The pressure of Ar to generate the plasma flame was 50 psi, which resulted in a flow rate 56 L/min (at 25° C. and 0.85 atm). The powders produced were collected using a Teflon-coated polyester filter with a pore size of 0.4 μm-1 μm in a stainless steel collector. As shown in FIG. 6(c), the main product under these conditions was WC₁₋ₓ and a small amount of WC was also present in the product. The degree of carburization was slightly increased compared to FIG. 6(a).

### Example 15

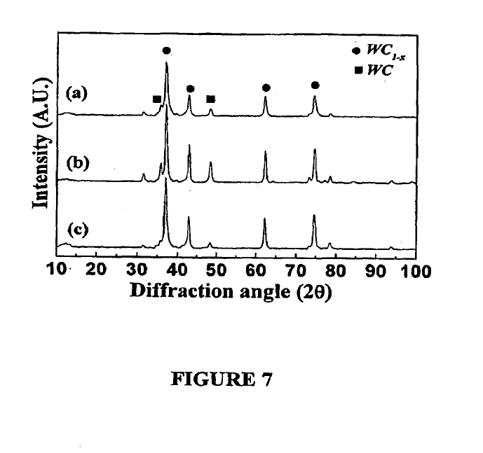

A mixture of CH₄ (99.9%) and argon was fed into the plasma flame with a CH₄ feeding rate of 1.5 L/min and an Ar feeding rate of 1 L/min. WCl₆ (99.9%) was fed into the plasma flame through a stainless steel delivery line at a rate of 3.5 g/min. The power of plasma torch was 13 kW. The pressure of Ar to generate the plasma flame was 20 psi, which resulted in a flow rate 29 L/min (at 25° C. and 0.85 atm). The powders produced were collected using a Teflon-coated polyester filter with a pore size of 0.4 μm-1 μm in a stainless steel collector. As shown in FIG. 7(a), the main product under these conditions was WC₁₋ₓ and a small amount of WC was also present in the product.

### Example 16

A mixture of CH₄ (99.9%) and argon was fed into the plasma flame with a CH₄ feeding rate of 1.5 L/min and an Ar feeding rate of 1 L/min. WCl₆ (99.9%) was fed into the plasma flame through a stainless steel delivery line at a rate of 3.5 g/min. The power of plasma torch was 18 kW. The pressure of Ar to generate the plasma flame was 20 psi, which resulted in a flow rate 29 L/min (at 25° C. and 0.85 atm). In addition, a secondary plasma gas of H₂ was added at 20 psi, which resulted in a flow rate of 0.66 L/min (at 25° C. and 0.85 atm). The powders produced were collected using a Teflon-coated polyester filter with a pore size of 0.4 μm-1 μm in a stainless steel collector. As shown in FIG. 7(b), the main products under these conditions were WC₁₋ₓ and WC. The degree of carburization was increased compared to FIG. 7(a).

### Example 17

A mixture of CH₄ (99.9%/*) and argon was fed into the plasma flame with a CH₄ feeding rate of 1.5 L/min and an Ar feeding rate of 1 L/min. WCl₆ (99.9%) was fed into the plasma flame through a stainless steel delivery line at a rate of 3.5 g/min. The power of plasma torch was 18 kW. The pressure of primary Ar to generate the plasma flame was 20 psi, which resulted in a flow rate 29 L/min (at 25° C. and 0.85 atm). In addition, a secondary plasma gas of H₂ was added at 45 psi, which resulted in a flow rate of 2.1 L/min (at 25° C. and 0.85 atm). The powders produced were collected using a Teflon-coated polyester filter with a pore size of 0.4 μm-1 μm in a stainless steel collector. As shown in FIG. 7(c), the main product under these conditions was WC₁₋ₓ and a small amount of WC was also present in the product. The degree of carburization was slightly increased compared to FIG. 7(a).

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of making a carbide-metal nanocomposite powder comprising:
a) introducing a metal carbide precursor into a reactor at a temperature sufficient to vaporize the metal carbide precursor in the presence of a carburizing agent to form a nanosize metal carbide; and
b) introducing a secondary metal precursor into the reactor at a temperature sufficient to vaporize the secondary metal precursor in the presence of a reducing agent and the nanosize metal carbide to form a reduced metal, collectively forming the carbide-metal nanocomposite powder.

2. The method of claim 1, further comprising the step of introducing an additive to the reactor.

3. The method of claim 2, wherein the additive comprises a secondary metal carbide precursor selected from the group consisting of titanium, tantalum, vanadium, niobium, chromium, molybdenum, silicon, zirconium, bafnium, and alloys, compounds or combinations thereof.

4. The method of claim 2, wherein the additive includes a grain growth inhibitor.

5. The method of claim 1, further comprising the step of collecting the carbide-metal nanocomposite powder using a filter.

6. The method of claim 1, wherein the carburizing agent comprises a member selected from the group consisting of methane, ethane, propane, higher hydrocarbon, carbon monoxide, and combinations thereof.

7. The method of claim 1, wherein the reducing agent comprises a member selected from the group consisting of hydrogen, carbon monoxide, methane, higher hydrocarbon, reformed natural gas, magnesium vapor, and combinations thereof.

8. The method of claim 1, wherein the reducing agent and carburizing agent are different.

9. The method of claim 1, wherein the metal carbide precursor is a refractory metal carbide precursor.

10. The method of claim 1, wherein the metal carbide precursor is a metal halide or carbonyl.

11. The method of claim 10, wherein the halide comprises a member selected from the group consisting of fluoride, chloride, bromide, iodide, and combinations thereof.

12. The method of claim 11, wherein the halide is chloride.

13. The method of claim 12, wherein the metal carbide precursor comprises WCl₆.

14. The method of claim 1, wherein the metal carbide precursor comprises a member selected from the group consisting of tungsten hexachloride (WCl₆), tungsten hexafluoride (WF₆), tungsten hexacarbonyl (W(CO)₆), ammonium paratungstate, volatile or soluble tungsten compounds, and combinations thereof.

15. The method of claim 1, wherein the metal carbide precursor is a metal halide or carbonyl of Mo, Ta, Nb, Zr, Hf, Cr, V, Ti or Si.

16. The method of claim 1, wherein the secondary metal precursor is introduced separately from the metal carbide precursor.

17. The method of claim 1, wherein the secondary metal precursor comprises a metal halide or carbonyl.

18. The method of claim 1, wherein the secondary metal precursor is a second metal carbide precursor.

19. The method of claim 1, wherein the secondary metal precursor is an elemental metal precursor.

20. The method of claim 1, wherein the secondary metal precursor comprises a member selected from the group consisting of cobalt, nickel, iron, manganese, aluminum, and combinations thereof.

21. The method of claim 20, wherein the secondary metal precursor comprises cobalt chloride (CbCl₂).

22. The method of claim 1, wherein the nanocomposite powder contains from about 1 wt % to about 30 wt % of the reduced metal.

23. The method of claim 1, wherein the temperature is from about 500° C. to about 10,000° C.

24. The method of claim 18, wherein the temperature is about 1300° C. to about 1450° C.

25. The method of claim 1, wherein the reactor is heated by plasma.

26. The method of claim 1, wherein the nanosize metal carbide is embedded within the reduced metal.

27. The method of claim 1, wherein the nanosize metal carbide and the reduced metal form a substantially homogenous mixture.

28. The method of claim 1, wherein the carbide-metal nanocomposite powder has a grain size of less than 50 nm.
